(19) United States
(12) Patent Application Publication
(10) Pub. No.: US 2010/0171635 A1
(43) Pub. Date: Jul. 8, 2010

(54) System And Method For Motion-Sensitive Remote Control For Audio-Visual Entertainment System

(75) Inventor: Luk Wah Jackson Chu, Kowloon (HK)

Correspondence Address: LATHROP & GAGE LLP, 4845 PEARL EAST CIRCLE, SUITE 201, BOULDER, CO, 80301, US

(73) Assignee: Ewig Industries Macao Commerical Offshore, Ltd.

(21) Appl. No.: 12/493,916

(22) Filed: Jun. 29, 2009

Related U.S. Application Data
(60) Provisional application No. 61/142,268, filed on Jan. 2, 2009.

(51) Int. Cl. G08C 19/00

(52) U.S. Cl. 340/825.69; 341/176

(57) ABSTRACT

A remote control device has one or more accelerometers for measuring a vertical acceleration and a horizontal acceleration caused by an operator gesturing with the device. Signals from the accelerometer enter a microcontroller and used to determine a gesture type; the microcontroller then generates an encoded command appropriate to a device to be controlled and broadcasts it with an infrared transmitter. The microcontroller distinguishes at least LEFT, RIGHT, UP, and DOWN gestures, and at least one gesture type causes the microcontroller to generate VOLUME UP commands with another gesture type causing the microcontroller to generate VOLUME DOWN commands. Additional embodiments distinguish clockwise and anticlockwise rotary gestures and assign them to appropriate commands. Embodiments for use with television reception have gesture types that generate CHANNEL UP and CHANNEL DOWN commands, while embodiments configured for use with DVD and VCR players and recorders have gesture types that generate PAUSE and PLAY commands.

### RELATED APPLICATIONS

The present application claims priority to the U.S. provisional application Ser. No. 61/142,268 filed 2 Jan. 2009, which is incorporated herein by reference.

### FIELD

The present document relates to the field of remote control devices for audio-visual entertainment systems. In particular, the document relates to remote control devices for use with a variety of entertainment systems, including televisions, video cassette recorders (VCRs), cable-television set-top boxes, satellite receivers, and digital versatile disk (DVD) recorders and players.

### BACKGROUND

Low cost accelerometers are now available. These devices typically have a small weight mounted with a simple spring, and are integrated apparatus for measuring deflection of the weight from a normal or rest position. As these devices are accelerated, or exposed to gravity, the weight is deflected and a signal indicative of the deflection is generated. In some accelerometers, the weight, spring, and apparatus for measuring deflection may be fabricated together by a monolithic micromachining and semiconductor fabrication process. These devices have been used for many applications, ranging from crash-sensing in automobile airbag systems to the Nintendo WII (a trademark, registration applied for, of Nintendo of America, Inc.).

Single-axis accelerometers typically measure deflection of a weight in one direction. Multiple axis accelerometers typically have multiple weights each having apparatus for measuring deflection, where deflection of each weight is measured along a different axis—multiple-axis accelerometers may therefore be assembled from several single-axis accelerometers oriented in different directions. Some two-axis accelerometers are fabricated on a single micromachined die utilizing two weights mounted on cantilever spring arms mounted at right angles to each other.

Home entertainment systems, including televisions, DVD (Digital Versatile Disk) players, VCRs (Video Cassette Recorders), and other audiovisual devices are often watched at night with limited lighting. Typical remote control devices require activation of particular buttons to generate particular commands. Further, upon picking up a remote control device, it may take an operator several seconds to locate, and place fingers upon, particular buttons. It is desirable to detect an operator's intent and generate desired commands without necessity of the operator locating the particular buttons.

### SUMMARY

A remote control device has one or more accelerometers for measuring a vertical acceleration and a horizontal acceleration caused by an operator gesturing with the device. Signals from the accelerometer enter a microcontroller and used to determine a gesture type; the microcontroller then generates an encoded command appropriate to a device to be controlled and transmits it with an infrared transmitter. The microcontroller distinguishes at least LEFT, RIGHT, UP, and DOWN gestures, and at least one gesture type causes the microcontroller to generate VOLUME UP commands with another gesture type causing the microcontroller to generate VOLUME DOWN commands. Embodiments for use with television reception have gesture types that generate CHANNEL UP and CHANNEL DOWN commands, while embodiments for use with DVD and VCR players and recorders have gesture types that generate PAUSE and PLAY commands.

A remote control device has at least one accelerometer for measuring a vertical acceleration and a horizontal acceleration and a microcontroller that determines gesture types from the accelerations. The microcontroller then determines encoded commands from the gesture types and transmits these commands with an infrared or radio-frequency transmitter. Determined gesture types include at least a LEFT, RIGHT, UP, and DOWN gestures. In alternative embodiments, circular gestures such as a clockwise and an anticlockwise gesture are also determined and assigned to specific commands.

### BRIEF DESCRIPTION OF THE FIGURES

FIG. 1 is a view of a remote control device, partially cut away to show a circuit board having at least one accelerometer attached thereto.

FIG. 2 is a block diagram of the remote control device of FIG. 1.

FIG. 3 illustrates gestures involving horizontal movement of the remote control device for signaling channel changes to a television receiver.

FIG. 4 illustrates an accelerometer signal generated by movement of the remote control device.

FIG. 5 illustrates a flowchart of actions taken by the microcontroller of the remote control device.

### DETAILED DESCRIPTION OF THE EMBODIMENTS

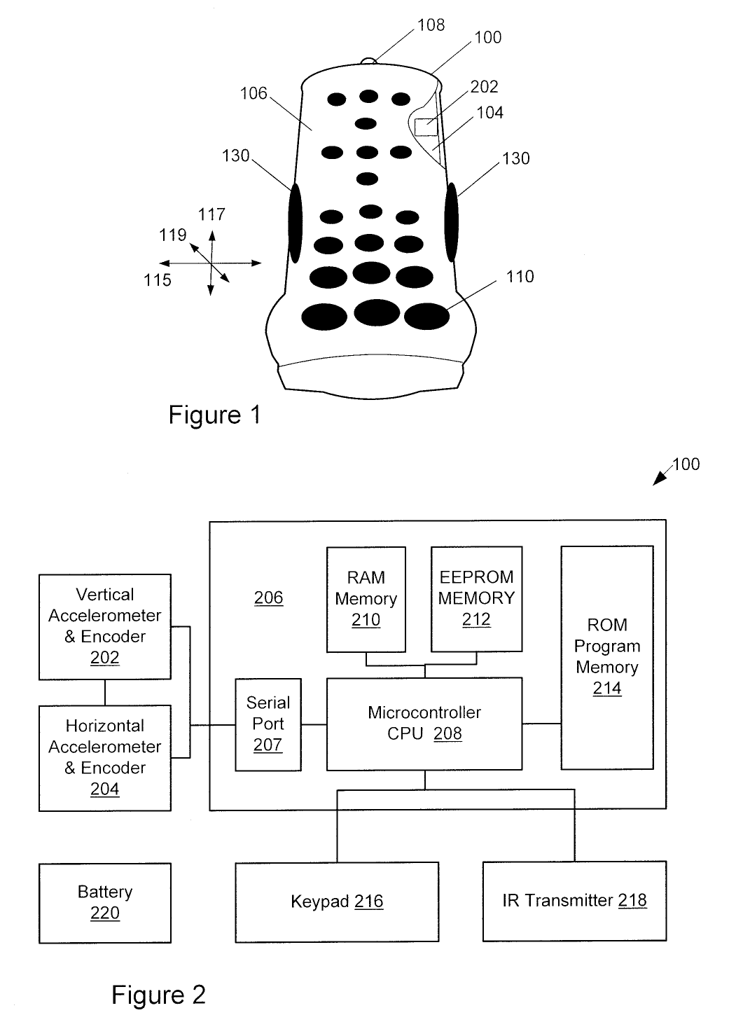

A remote control device 100 is illustrated in FIG. 1 and FIG. 2. The device 100 has at least one accelerometer 202, 204 attached to a printed circuit board 104 enclosed within a housing 106. The remote also has a broad-focus infrared transmitter light-emitting diode 108 and several keys 110 of a keypad 216. In an embodiment, the keypad is formed integrally with a portion of housing 106

Also attached to printed circuit board 104 is a microcontroller system 206 coupled to receive digitally encoded signals from accelerometers 202, 204 through a serial port 207. The microcontroller system 206 has a microcontroller CPU 208, a RAM memory 210, an EEPROM memory 212, and a ROM program memory 214 as known in the art of microcontrollers. In an embodiment, ROM program memory 214 is an EPROM memory. One or more of the memories 210, 212, 214 may be incorporated within the same integrated circuit as the microcontroller CPU 208. Microcontroller CPU 208 is also coupled to scan keypad 216, and to provide signals to an infrared transmitter 218, of which light emitting diode 108 is a part. Infrared transmitter 218 is provided for broadcasting commands to a device to be controlled. A local battery 220 is provided within device 100 to provide power to the device.

In an embodiment, accelerometer 202 is a multi-axis accelerometer capable of measuring accelerations in a horizontal axis 115 (FIG. 1) and in a vertical axis 117. In an alternative embodiment, accelerometer 202 is a single-axis accelerometer capable of measuring accelerations in the horizontal axis 115 and second accelerometer 204 is provided for measuring accelerations in the vertical axis 117. In alternative embodiments, accelerometers are also provided for measuring acceleration in a longitudinal axis 119. In an embodiment, the accelerometers 202, 204, provide a digitally-encoded signal representing acceleration to serial port 207; in alternative embodiments, accelerometers 202, 204 provide analog signals to an analog-to-digital converter (not shown) coupled to CPU 208.

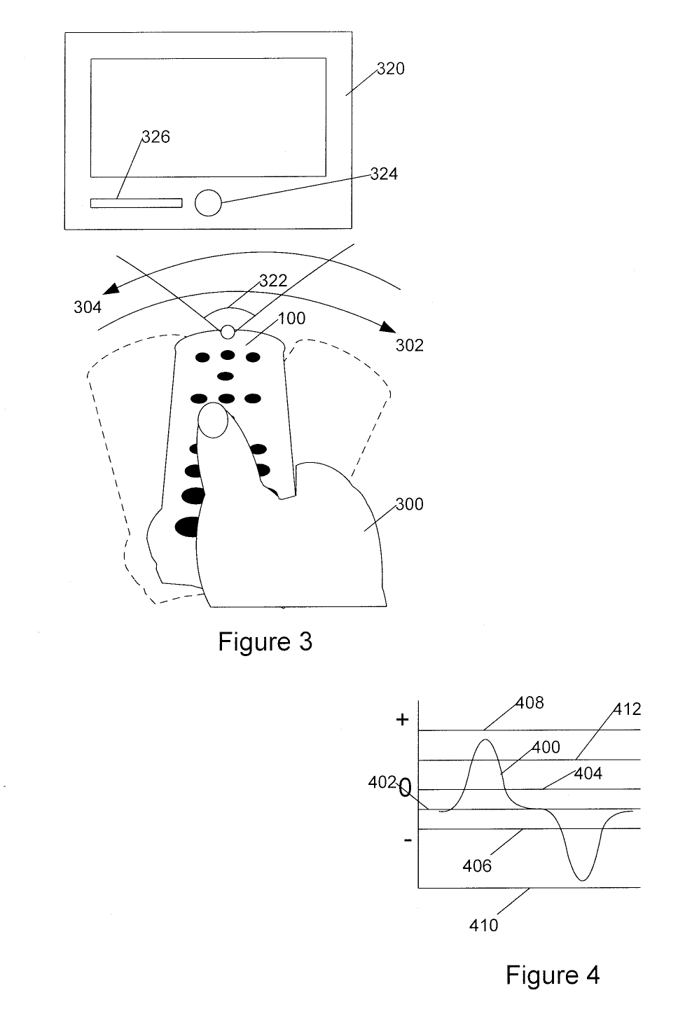

The device 100 is lightweight and portable so it may be readily picked up in an operator's hand 300 (FIG. 3). The operator may gesture with the device 100, for example the operator may wave the device 100 from a center or right orientation to the left 304, or from a center or left orientation to the right 302. Similarly, the operator may wave the device from a center or up position downwards; or may wave the device from a center or down position upwards to a center or up orientation. Typically, the gestures are performed with the device 100 aimed generally in the direction of the device to be controlled, such as a television receiver 320. Infrared LED 108 has a broad beam emission angle 322 such that an infrared receiver 324 will lie within the beam at the end of a gesture 302, 304.

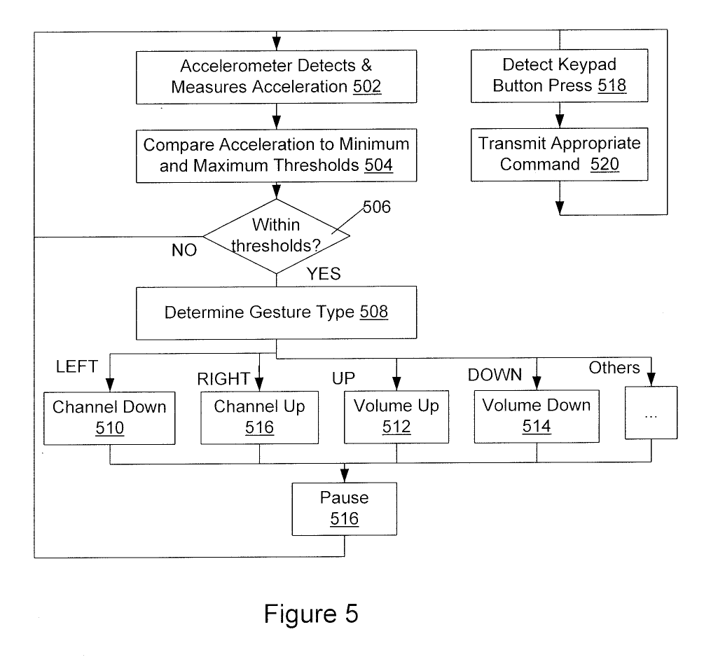

Operation of the device is illustrated with reference to the flowchart of FIG. 5. As the operator gestures with the device 100, the accelerometers 202, 204 detect and measure acceleration 502 of the device and produce signals 400 as illustrated in FIG. 4 that deviate from a baseline 402. Separate signals are provided to the CPU 208 for accelerations in a horizontal axis 115, and a vertical axis 117. In order to exclude responses to ordinary handling, signals not rising above a first positive threshold 404, or not dropping below a first negative threshold 406, are ignored. Similarly, in order to exclude signals due to collisions with hard objects, such as those produced by placing or dropping the device 100 onto a hard object such as a table, signals rising in instantaneous intensity above a second positive threshold 408 or below a second negative threshold 410 are ignored. The measured acceleration signals 400 are thus compared 504 to these first and second thresholds.

When signals between the positive thresholds 404 and 408, or between the negative thresholds 406, 410 are found 506, CPU 208 then determines 508 a gesture type. CPU 208 determines gesture types under control of a firmware program provided in ROM program memory 214. For example, if a signal 400 for horizontal axis 115 is found positive between thresholds 404 and 408 for a time interval, followed by negative between thresholds 406 and 410, a LEFT gesture 304 is determined. If signal 400 for horizontal axis 115 is found negative between thresholds 406 and 410 for a time interval, followed by positive between thresholds 404 and 408 for a time, a RIGHT gesture 302 is determined. Similarly, if the vertical axis signal is positive between thresholds followed by negative between thresholds an UP gesture is determined, and if the vertical axis signal is negative between thresholds followed by positive between thresholds, a DOWN gesture is determined.

In an alternative embodiment, accelerometer signal polarity and threshold polarity is reversed from that discussed in the previous paragraph.

Since the weights of accelerometers respond to gravity as well as to acceleration, the accelerometers will respond to rotation of the device 100 as well as to linear movements such as the LEFT, RIGHT, UP and DOWN gestures. For example, brief counterclockwise rotation will cause the horizontal axis accelerometer to indicate acceleration towards the right simultaneously with acceleration downwards. In an embodiment, CPU 208 computes a vector sum of accelerations measured along the horizontal and vertical axes by the accelerometers 202, 204; in purely rotational movements, this vector sum will remain constant. In this embodiment, to ensure that the device 100 transmits infrared commands only for intentional gestures made by the user, the CPU generates commands only when the vector sum momentarily differs from a baseline level by an amount exceeding a predetermined threshold.

In an alternative embodiment, responses to rotational gestures by the device are excluded to an extent by ignoring movements that generate a positive signal 400 above first positive threshold 404 that are not followed within a brief time by a negative signal 400 below first negative threshold 406, and by ignoring movements that generate a negative signal 400 below first negative threshold 404 that is not followed within a brief time by a positive signal 400 above first negative threshold 406.

Once the gesture type is determined 508, CPU 208 determines an appropriate encoding of a command to television receiver 320, the command is encoded, and CPU 208 directs infrared transmitter 218 to broadcast the command to the receiver 320. In an embodiment, this encoding is determined according to command tables associated with a television receiver 320 type programmed into the device 100 when first purchased by the operator, and stored in CMOS or EEPROM memory 212 as known in the art of universal remote controls.

In an alternative embodiment, there are several device selection buttons provided on the remote, each of which is associated in EEPROM memory 212 with a user-configurable device type, each of which may have a different command table. With this embodiment, the device type associated with each button may be selected from any one of a large number of particular television receivers, digital versatile disk (DVD) players and recorders, video cassette recorders, satellite receivers, cable-television set-top boxes, digital video recorders (DVRs), camcorders, and other devices such as are common in home entertainment systems and which commonly have the ability to receive commands from remote control devices with internal infrared and/or radio frequency receivers. In a particular embodiment, device type is associated with each device select button by entering a four digit device selection code. In this way, the remote control device 100 can be made compatible with a wide variety of devices made by many different manufacturers.

The remote control device 100 is also compatible with a variety of devices that incorporate more than one function of television receivers, digital versatile disk (DVD) players and recorders, video cassette recorders, satellite receivers, cable-television set-top boxes, and digital video recorders (DVRs), including devices such as television receivers having internal DVD recorders or players.

In an alternative embodiment, such as may be sold with a television receiver 320, the encoding is determined by a factory setting stored in ROM program memory 214.

In an alternative embodiment, a small radio-frequency transmitter is provided in place of, or in addition to, IR transmitter 218. This embodiment may be used with radio-frequency-controllable entertainment devices located in other rooms, or with a radio-frequency to infrared control relay transmitter located near infrared-controllable entertainment devices located in other rooms.

In an embodiment, if a LEFT gesture is determined 508, a CHANNEL DOWN command is transmitted 510. If a RIGHT gesture is determined 508, a CHANNEL UP command is transmitted 516, if an UP gesture is determined 508, a VOLUME UP command is transmitted 512, and if a DOWN gesture is determined 508, a VOLUME DOWN command is transmitted 514. In an alternative embodiment, LEFT and RIGHT gestures produce VOLUME commands, and UP and DOWN gestures produce CHANNEL commands. Additional gestures and command types may be detected, including rotary and diagonal gestures as described hereafter. After transmitting the command, the device 516 pauses briefly to permit the operator to reposition the device 100 for another gesture without reversing the gesture; then the device 100 waits for another accelerometer detection or keypress.

In the event the operator presses a button 10 on keypad 216, CPU 208 detects 518 which button has been pressed. The CPU encodes a command appropriate to the television receiver 320 type and transmits 520 the appropriate command in the manner known in the art of infrared remote control devices. In an embodiment, there are buttons provided on keypad 216 for generating CHANNEL UP, CHANNEL DOWN, VOLUME UP, and VOLUME DOWN commands, as well as POWER ON and POWER OFF commands.

In an alternative embodiment, the horizontal accelerometer signals 400 are compared to a third threshold 412 lying between second threshold 408 and first threshold 404, in order to discriminate between vigorous and moderate gestures. When vigorous gestures are determined, a sequence of four CHANNEL UP or DOWN commands is transmitted instead of the single CHANNEL command generated when a moderate gesture is determined. This sequence of four commands represents a PAGE DOWN command. In alternative embodiments, separately encoded PAGE UP and PAGE DOWN commands may be generated if television 320 is capable of receiving and acting upon them, instead of requiring a sequence of single-CHANNEL-UP or DOWN commands. In other embodiments the sequence of CHANNEL commands generated as a page command is a sequence of eight instead of four CHANNEL-UP or CHANNEL-DOWN commands.

In an alternative embodiment, a diagonal left and down gesture is determined when both the horizontal accelerometer signal and the vertical accelerometer signal are above first positive thresholds, and a diagonal up and right gesture is determined when both the horizontal and vertical accelerometer signals are below first positive thresholds. In this embodiment, the PAGE DOWN sequence is generated by a diagonal left and down gesture, and the PAGE UP sequence is generated by the diagonal up and right gesture.

There are other devices to be controlled 320 for which the device 100 is useful, including devices for playing recorded video such as of video cassette recorders (VCRs), video cassette players, and digital versatile disk (DVD) players. In an alternative embodiment, where the device to be controlled 320 is a DVD or VCR recorder or player instead of a television, or is a television with an internal DVD or VCR player 326 currently playing a DVD, a first left gesture generates a PAUSE command, and a second left gesture in a short time interval, or a vigorous left gesture, generates a REWIND for VCRs and a SKIP BACKWARDS for DVDs. Similarly, a first right gesture generates a PLAY command for DVDs and VCRs, and a second or vigorous right gesture generates a SKIP FORWARDS for DVDs and a FAST FORWARD for VCRs. In these embodiments, volume commands are generated from UP and DOWN gestures as heretofore described. In alternative embodiments, other commands appropriate for the device to be controlled 320 are generated.

In alternative embodiments, other gesture types, such as UP LEFT, or DOWN RIGHT, may be determined, and assigned to commands appropriate to the device to be controlled.

In an alternative embodiment, accelerometers 202, 204, are provided to respond to movements in all three axes 115, 117, and 119. In this embodiment, additional gesture types are determined including a STAB or PUSH-AWAY gesture, comprising a forward movement; and a YANK gesture, comprising a rearward movement. In this embodiment, for television receivers the STAB gesture is assigned to a POWER-ON command, and the YANK gesture to a POWER-OFF command. In this embodiment, for DVD players and recorders, the STAB gesture is assigned to a SELECT command, and the YANK gesture to a MENU command.

In an alternative embodiment, rotational gestures of the device 100 are determined. In this embodiment, CPU 208 computes a vector sum of accelerations measured along the horizontal and vertical axes by the accelerometers 202, 204; in purely rotational movements this vector sum remains nearly constant thereby permitting CPU 208 to distinguish rotational movements from diagonal linear gestures such as LEFT AND DOWN or RIGHT AND DOWN. The direction of rotation is determined by determining a sequence of vertical and horizontal accelerations measured by the accelerometer-encoders 202, 204, and matching the sequence to one of several patterns. For example, an UP motion in a sequence rapidly followed in order by a RIGHT and then by a DOWN motion can be determined to represent a clockwise rotation, and an UP motion in a sequence rapidly followed in order by a LEFT and DOWN motion can be determined to represent a counterclockwise rotation.

In this embodiment counterclockwise rotation is assigned to a particular command, such as PAGE DOWN, and clockwise rotation is assigned to a second command such as PAGE UP.

In an alternative embodiment, additional double-clockwise and double-counterclockwise rotation motions are determined by matching a sequence of vertical and horizontal accelerations as measured by the accelerometer-encoders 202, 204 to appropriate patterns. For example, a rapid sequence of accelerations matching a pattern of peaks of UP, then RIGHT, then DOWN, then LEFT, then UP, then RIGHT, then DOWN can be determined to be a double-clockwise motion. A similar pattern of peak accelerations of UP, then LEFT, then DOWN, then RIGHT, then UP, then LEFT, then DOWN can be determined to be a double-counterclockwise motion.

In alternative embodiments, the gestural movements determined by CPU 208 as heretofore described are assigned to combinations of commands differing from those described above.

In an alternative embodiment, some commands are disambiguated by reference to a context in which the commands gestures are given. For example, a LEFT gesture may be encoded as a Volume Up command when the entertainment system is not processing a menu, but as a Left Movement Within Menu when processing a menu. In a particular embodiment, menu mode is assumed after a “Menu” button has been pressed on the remote, and persists until an “OK”, “Enter”, or “Cancel” button is pressed or until a timeout of one minute after the remote detects a gesture or button press.

In particular embodiments, motions are assigned to commands as follows:

| | | Embodiment 2 | |
|---|---|---|---|
| | | | Not in |
| | Embodiment 1 | In Menu | Menu |
| UP | Channel Up | | |
| DOWN | Channel Down | | |
| LEFT | Volume Up | Left | Volume Up |
| RIGHT | Volume Down | Right | Volume |
| | | | Down |
| CLOCKWISE | Next or Fast | Next | |
| | Forward | | |
| DOUBLE CLOCKWISE | | Fast Forward | |
| COUNTERCLOCKWISE | Previous or | Previous | |
| | Rewind | | |
| DOUBLE | | Rewind/Fast Reverse | |
| COUNTERCLOCKWISE | | | |
| STAB | Play or Pause or | Play/Pause | OK/Enter |
| | OK/Enter | | |
| YANK | Stop or Go Back | Stop | Go Back |

In an alternative embodiment, in order to conserve battery life by reducing power consumption of the accelerometer/encoders 202, 204, detection of accelerations and gestures by the remote is only performed when, or within a few seconds after, any of several gesture-enable buttons 130 on the remote are pressed. In order to render this embodiment of the remote easy to activate, the gesture-enable buttons 130 are considerably larger than other buttons, and are located on sides and bottom of the remote.

While the invention has been particularly shown and described with reference to particular embodiments thereof, it will be understood by those skilled in the art that various other changes in the form and details may be made without departing from the spirit and scope of the invention. It is to be understood that various changes may be made in adapting the invention to different embodiments without departing from the broader inventive concepts disclosed herein and comprehended by the claims that follow.

What is claimed is:

1. A remote control device for a device to be controlled, the remote control device comprising:
at least one accelerometer for measuring a vertical acceleration and a horizontal acceleration and producing acceleration signals;
a microcontroller coupled to receive the acceleration signals and to determine a gesture therefrom, for determining an encoded command appropriate to the device to be controlled in response to the acceleration signals;
a transmitter selected from the group consisting of radio frequency and infrared transmitters, the transmitter coupled to receive encoded commands from the microcontroller and to broadcast the encoded commands;
wherein determined gesture types comprise at least a LEFT, RIGHT, UP, and DOWN gestures; and
wherein at least one gesture type causes the microcontroller to broadcast VOLUME UP commands, and at least one different gesture type causes the microcontroller to broadcast VOLUME DOWN commands.

2. The remote control device of claim 1, wherein the device to be controlled comprises a television receiver, and at least one gesture type causes the transmitter to broadcast CHANNEL DOWN commands, and another gesture type causes the transmitter to broadcast CHANNEL UP commands.

3. The remote control device of claim 1, wherein at least one gesture type causes the microcontroller to generate a command selected from the group consisting of a PAGE UP command and a sequence of several CHANNEL UP commands.

4. The remote control device of claim 1, wherein the microcontroller determines the encoded command according to a user-configurable device type, and wherein the transmitter is an infrared transmitter.

5. The remote control device of claim 4, wherein the user configurable device type is selected from a group of devices comprising devices selected from the group consisting of video cassette recorders, video cassette players, and digital versatile disk players, and at least one gesture type causes the microcontroller to generate an encoded PAUSE command.

6. The remote control device of claim 1, wherein the gesture types further comprise a clockwise rotary gesture and an anticlockwise rotary gesture.

7. The remote control device of claim 1, wherein the device to be controlled is a device for playing recorded video, and wherein at least one gesture type causes the remote control device to broadcast a PAUSE command and another gesture type causes the remote control device to broadcast a PLAY command.

8. A method of controlling a device comprising:
detecting accelerations with at least one accelerometer;
determining a gesture type associated with the accelerations;
determining a command associated with the gesture type;
determining an encoding for the command, the encoding appropriate to a particular device; and
transmitting the encoding of the command with an infrared transmitter.

9. The method of claim 8, wherein the at least one accelerometer is capable of detecting accelerations in at least two axes, and wherein determining a gesture type comprises detecting at least an UP, a DOWN, a LEFT, and a RIGHT gesture type.

10. The method of claim 9, wherein an UP gesture is associated with a CHANNEL-UP command.

11. The method of claim 9, wherein determining a gesture type further comprises determining a CLOCKWISE and a COUNTERCLOCKWISE gesture.

12. The method of claim 9, wherein the at least one accelerometer is capable of detecting accelerations in at least three axes, and wherein determining a gesture type further comprises determining a STAB and a YANK gesture as herein defined.

13. The method of claim 8 further comprising:
selecting the particular device from a group of preconfigured devices.

14. The method of claim 13 wherein the particular device incorporates functionality of a television receiver.
